(19) United States
(12) Patent Application Publication
(10) Pub. No.: US 2025/0159725 A1
(43) Pub. Date: May 15, 2025

(54) PEER-TO-PEER RESOURCE MANAGEMENT

(71) Applicant: Samsung Electronics Co., Ltd., Suwon-si (KR)

(72) Inventors: Rubayet Shafin, Frisco, TX (US); Boon Loong Ng, Plano, TX (US)

(21) Appl. No.: 18/930,932

(22) Filed: Oct. 29, 2024

Related U.S. Application Data
(60) Provisional application No. 63/597,995, filed on Nov. 10, 2023.

(51) Int. Cl. H04W 74/0816; H04W 28/02

(52) U.S. Cl. CPC H04W 74/0816; H04W 28/0268

(57) ABSTRACT

A station (STA) in a wireless network, comprising a memory and a processor coupled to the memory, the processor configured to transmit, to an access point (AP), a request frame that requests a resource from the AP for a P2P group to which the STA belongs; receive, from the AP, a trigger frame that allocates a TXOP; and transmit, to a peer STA in the P2P group, one or more frames within the TXOP.

CROSS-REFERENCE TO RELATED APPLICATION(S)

This application claims the benefit of priority from U.S. Provisional Application No. 63/597,995, entitled “P2P RESOURCE MANAGEMENT” filed Nov. 10, 2023, which is incorporated herein by reference in its entirety.

### TECHNICAL FIELD

This disclosure relates generally to a wireless communication system, and more particularly to, for example, but not limited to, peer-to-peer (P2P) resource management in wireless networks.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHZ, 5 GHZ, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

One aspect of the present disclosure provides a station (STA) in a wireless network, comprising a memory and a processor coupled to the memory. The processor is configured to transmit, to an access point (AP), a request frame that requests a resource from the AP for a P2P group to which the STA belongs. The process is configured to receive, from the AP, a trigger frame that allocates a transmission opportunity (TXOP). The processor is configured to transmit, to a peer STA in the P2P group, one or more frames within the TXOP.

In some embodiments, the processor is further configured to transmit, to the peer STA, a frame that reallocates a portion of the TXOP.

In some embodiments, the processor is further configured to receive, from the AP, a response frame in response to the request frame, the response frame including an indication of acceptance, rejection, or an alternative to the request in the request frame.

In some embodiments, the response frame includes a quality of service (QOS) characteristics element that includes the alternative to the request in the request frame.

In some embodiments, the request frame includes a P2P group identifier or a flow identifier that identifies the P2P group, wherein the flow identifier is a stream classification service identifier or a target-wake-time (TWT) flow identifier.

In some embodiments, the request frame includes a quality of service (QOS) characteristics element that includes information associated with a traffic requirement of the P2P group.

In some embodiments, the request frame includes information on one or more peer STAs in the P2P group for which the resource is requested.

One aspect of the present disclosure provides an access point (AP) in a wireless network, comprising: a memory; and a processor coupled to the memory. The processor is configured to receive, from a station (STA), a request frame that requests a resource from the AP for a P2P group to which the STA belongs. The processor is configured to transmit, to the STA, a trigger frame that allocates a transmission opportunity (TXOP) to the P2P group.

In some embodiments, the processor is further configured to transmit, to the STA, a response frame in response to the request frame, the response frame including an indication of acceptance, rejection, or an alternative to the request in the request frame.

In some embodiments, the response frame includes a quality of service (QOS) characteristics element that includes the alternative to the request in the request frame.

In some embodiments, the request frame includes a P2P group identifier or a flow identifier that identifies the P2P group, wherein the flow identifier is a stream classification service identifier or a target-wake-time (TWT) flow identifier.

In some embodiments, the request frame includes a quality of service (QOS) characteristics element that includes information associated with a traffic requirement of the P2P group.

In some embodiments, the request frame includes information on one or more peer STAs in the P2P group for which the resource is requested.

### BRIEF DESCRIPTION OF THE DRAWINGS

FIG. 1 illustrates an example of a wireless network in accordance with an embodiment.

FIG. 2A illustrates an example of AP in accordance with an embodiment.

FIG. 2B illustrates an example of STA in accordance with an embodiment.

FIG. 3 illustrates an example of multi-link communication operation in accordance with an embodiment.

FIG. 4 illustrates an example network in accordance with an embodiment.

FIG. 5 illustrates P2P communication between STAs in a P2P group in accordance with an embodiment.

FIG. 6 illustrates P2P communication among STAs in an established P2P group in accordance with an embodiment.

FIG. 7 illustrates an STA starting a new P2P TWT Group in accordance with an embodiment.

FIG. 8 illustrates group based triggering for P2P communication in accordance with an embodiment.

FIG. 9A illustrates an example of a QoS characteristic element in accordance with an embodiment.

FIG. 9B illustrates an example of a Control Info field within the QoS characteristic element in accordance with an embodiment.

FIG. 10 illustrates a flow chart of an example process by an STA of requesting resources for a P2P group in accordance with an embodiment.

FIG. 11 illustrates a flow chart of an example process by an AP of allocating resources to a P2P group in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

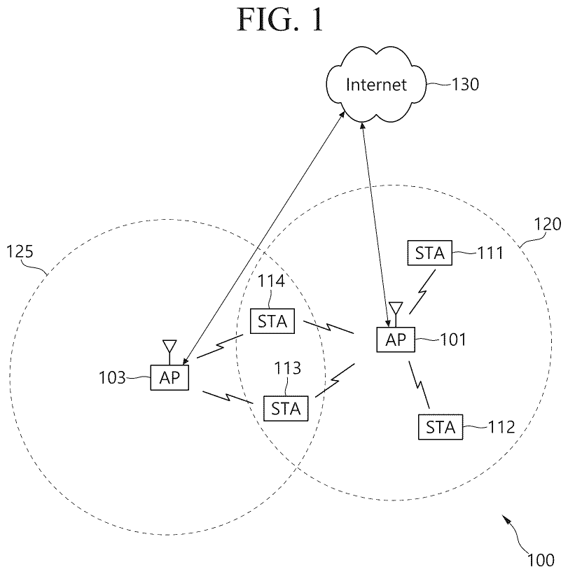

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

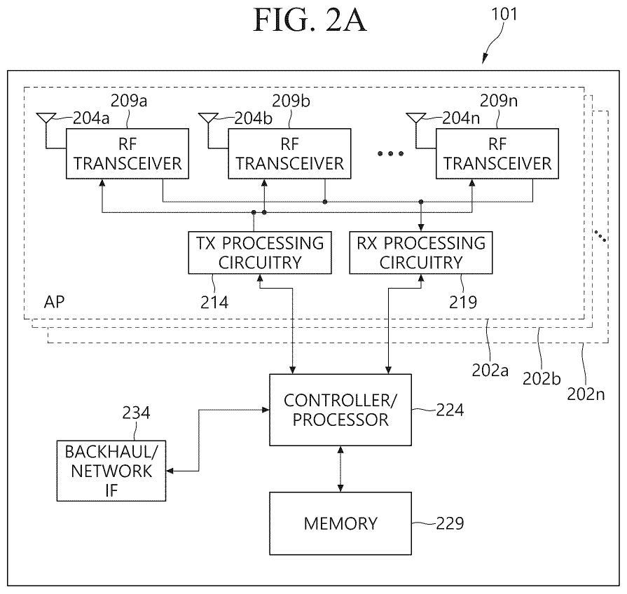

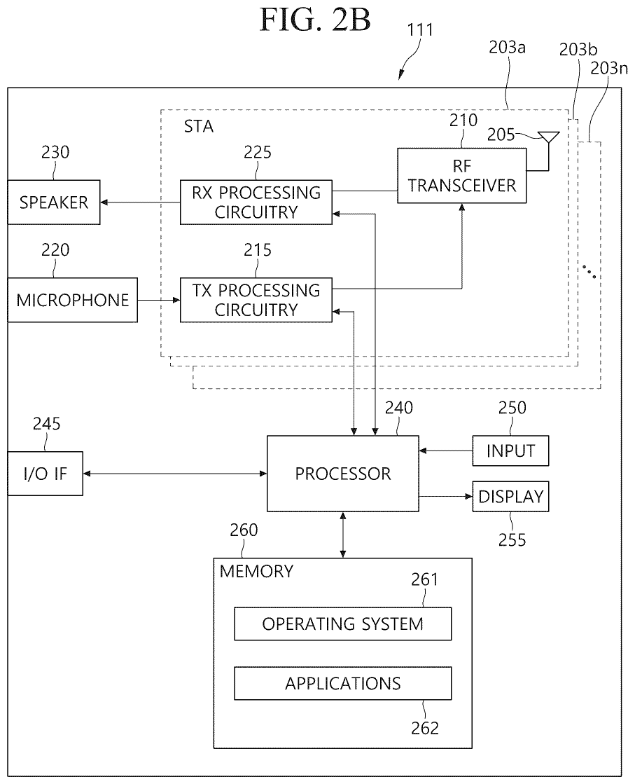

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementations of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

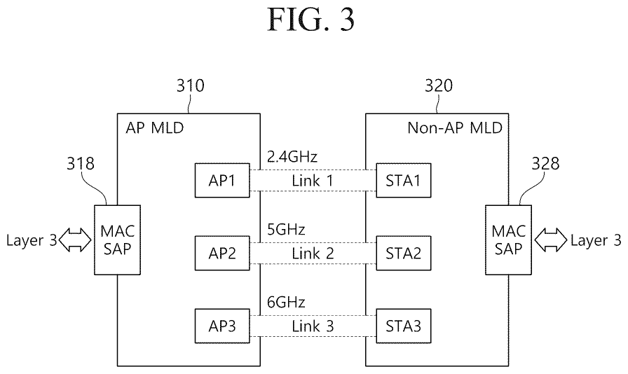

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA I may set up Link 1 which operates in 2.4 GHz band. Similarly, the AP 2 and the STA 2 may set up Link 2 which operates in 5 GHZ band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications,” ii) IEEE 802.11ax-2021, “Wireless LAN Medium Access Control (MAC) and Physical Layer (PHY) Specifications,” and ii) IEEE P802.11be/D3.0, “Wireless LAN Medium Access Control (MAC) and Physical Layer (PHY) Specifications.”

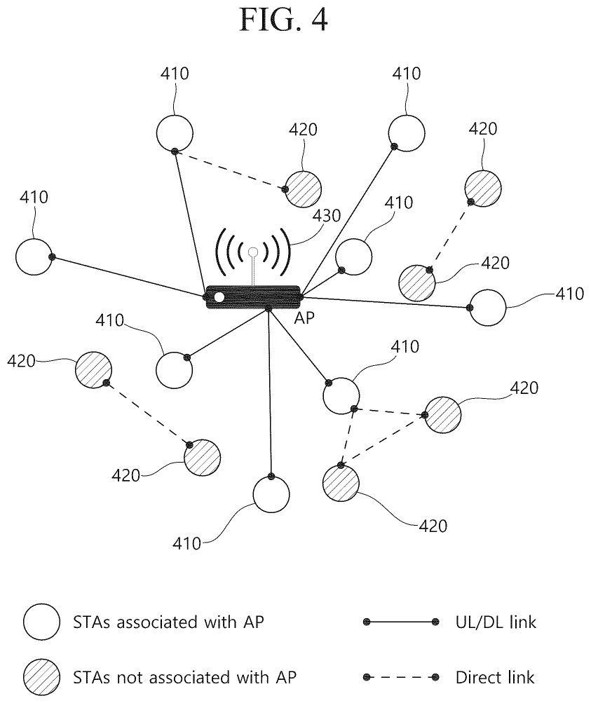

FIG. 4 shows an example network in accordance with an embodiment. The network depicted in FIG. 4 is for explanatory and illustration purposes. FIG. 4 does not limit the scope of this disclosure to any particular implementation.

In FIG. 4, a plurality of STAs 410 are non-AP STAs associated with AP 430, and a plurality of STAs 420 are non-AP STAs which are not associated with AP 430. Additionally, solid lines between STAs represent uplink or downlink with AP 430, while the dashed lines between STAs represent a direct link between STAs.

Next generation WLAN system needs to provide improved support for low-latency applications. Today, it is common to observe numerous devices operating on the same network. Many of these devices may have a tolerance for latency, but still compete with the devices running low-latency applications for the same time and frequency resources. In some cases, the AP as a network controller may not have enough control over the unregulated or unmanaged traffic that contends with the low-latency traffic within the infrastructure basic service set (BSS). In some embodiments, the infrastructure BSS is a basic service set that includes an AP and one or more non-AP STAs, while the independent BSS is a basic service set where non-AP STAs communicate with each other without the need for a centralized AP. Some of the unregulated or unmanaged traffic that interferes with the latency-sensitive traffic in the BSS of the AP may originate from uplink, downlink, or direct link communications within the infrastructure BSS that the AP manages. Another source of the interference may be transmission from the neighboring infrastructure OBSS (Overlapping Basic Service Set), while others may come from neighboring independent BSS or P2P networks. Therefore, the next generation WLAN system needs mechanisms to more effectively handle unmanaged traffic while prioritizing low-latency traffic in the network.

Currently, when a TXOP is allocated to a STA, only that STA can utilize the TXOP for transmitting to its peer STAs. As such, a peer STA may not be able to transmit utilizing that TXOP, which may increase latency.

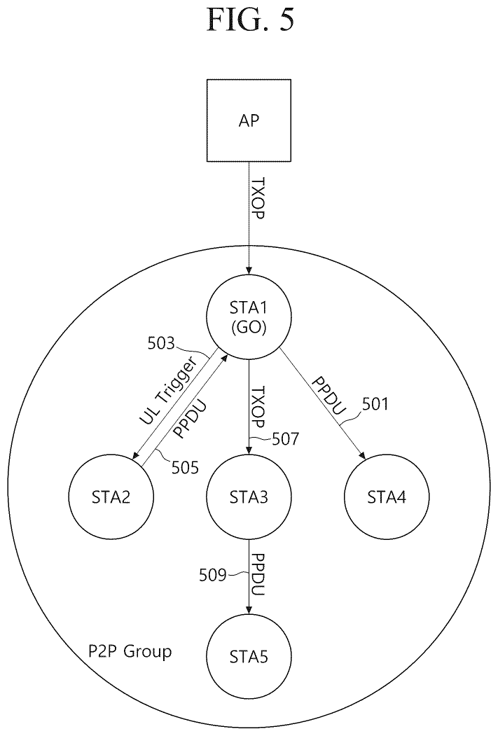

FIG. 5 illustrates P2P communication between STAs in a P2P group in accordance with an embodiment. In particular, FIG. 5 illustrates a P2P group owner (for example, GO in Wi-Fi direct or mobile AP) utilizing a TXOP received from the infrastructure AP and using the TXOP to either transmit physical layer protocol data units (PPDUs) to other STAs in the P2P group or trigger other STAs within the same group for transmitting to the group owner (STA1). In particular, STA1 is transmitting a PPDU 501 to STA4. STA1 transmits a UL Trigger frame 503 to STA2 and receives a PPDU 505 from STA2. STA1 allocates a TXOP 507 to STA3 and STA3 transmits a PPDU to STA5.

In some embodiments, a group-specific P2P resource allocation may be helpful so that any STA that falls into that P2P group can utilize the allocated resources. Accordingly, in some embodiments, an AP can allocate its channel resources (e.g., TXOP) to a group of STAs where the STAs are within a P2P group. In some embodiments, a STA that is a member of a P2P group can solicit resources for that P2P group to the infrastructure AP.

In some embodiments, a P2P group can be identified using different techniques. In some embodiments, a P2P group may be explicitly identified using a P2P group ID. In some embodiments, each STA within the P2P group can indicate to the AP its P2P group ID.

In some embodiments, a P2P group may be identified using implicit techniques. In some embodiments, a common flow ID, such as, for example, a stream classification service (SCS) ID or a target-wake-time (TWT) flow ID may be used to identify a P2P group. In some embodiments, each P2P STA, while setting up a P2P TWT with the AP, can use the same flow ID. In certain embodiments, a “P2P Flow ID” field may be used to identify a P2P group. Accordingly, using the identifier information, an AP can determine which STAs are within the same P2P group.

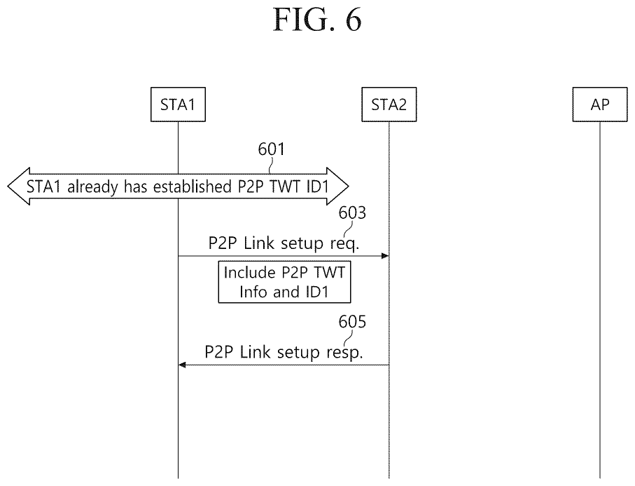

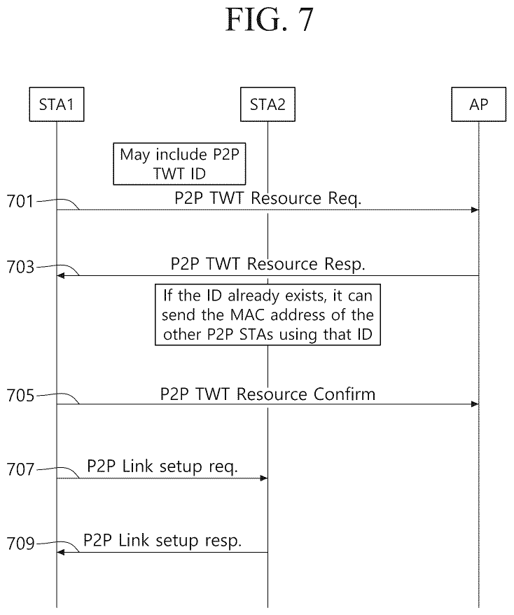

In some embodiments, the AP can transmit a trigger frame based on the identifier information (e.g., flow ID, P2P Group ID, among other identifiers). In some embodiments, the AP can allocate resources based on cumulative resource request arriving from multiple members within a same group. Two scenarios are illustrated in FIG. 6 and FIG. 7 that highlight the P2P group based resource allocation and utilization in accordance with several embodiments.

FIG. 6 illustrates a P2P communication among STAs in an established P2P group in accordance with an embodiment. Although one or more operations are described or shown in particular sequential order, in other embodiments the operations may be rearranged in a different order, which may include performance of multiple operations in at least partially overlapping time periods.

In particular, FIG. 6 illustrates a scenario where STA1 has already established a P2P TWT with another peer STA and has been using a particular P2P TWT ID. As illustrated, STA1 is communicating with STA2.

In operation 601, STA1 has already established a P2P TWT IDI. In some embodiments, each STA within the P2P group can indicate to the AP its P2P group ID. In some embodiments, an STA may use a flow ID such as a Stream Classification Service ID or a TWT Flow ID.

In operation 603, STA1 transmits to STA2 a P2P Link Setup Request frame which includes the P2P TWT information and ID. In some embodiments, the STA1 can send an SCS Request frame. In the SCS request frame, the STA1 can indicate that the request is for TXOP allocation for the P2P group.

In operation 605, STA2 transmits to STA1 a P2P Link Setup Response frame.

FIG. 7 illustrates a scenario where STA1 intends to start a new P2P TWT Group. Although one or more operations are described or shown in particular sequential order, in other embodiments the operations may be rearranged in a different order, which may include performance of multiple operations in at least partially overlapping time periods. In particular, FIG. 7 illustrates communication between STA1, STA2 and AP.

In operation 701, STA1 transmits to the AP, a P2P TWT Resource Request frame that includes a P2P TWT ID. In some embodiments, if the STA1 intends to request for channel resources to the AP for the P2P group, then the STA1 can send an SCS Request frame to the AP. In the SCS request frame, the STA1 can indicate that the request is for TXOP allocation for the P2P group. In certain embodiments, in order to request for channel resource or TXOP, the STA1 can send any other management frame and indicate that this management frame is a request for channel resource or TXOP for the P2P group indicated in the requesting management frame.

In operation 703, the AP transmits to STA1, a P2P TWT Resource Response frame that, if the P2P TWT ID already exists, can include the MAC address of the other P2P STAs using that P2P TWT ID. In some embodiments, the AP can send an SCS response frame to STA1 indicating whether the AP accepts, rejects, or suggests an alternative set of SCS parameters corresponding to the received SCS request. If the AP suggests an alternative set of parameters, then the AP can include a QoS Characteristics element in the SCS response frame transmitted to the STA1, where the QoS Characteristics element carries SCS parameters corresponding to the parameters suggested by the AP. Subsequently, if the STA1 sends a second SCS request frame with the parameters suggested by the AP, then the AP is highly likely to accept the second request.

In operation 705, STA1 transmits to AP, a P2P TWT Resource Confirm frame. The

In operation 707, STA1 transmits to STA2 a P2P Link Setup Request frame. In some embodiments, the P2P Link Setup Request frame may request to setup a link between STA1 and STA2.

In operation 709, STA2 transmits to STA1, a P2P Link Setup Response frame. In some embodiments, the P2P Link Setup Response frame may include information regarding confirmation of the link that is setup between STA1 and STA2.

In some embodiments, in a group-based triggering mechanism, any STA can transmit using the PPDU. In some embodiments, an STA in a P2P group may further relay the TXOP. In some embodiments, a contention may be within the P2P group. In some embodiments, the triggering mechanism may be used for a Tunneled Direct Link Setup (TDLS) where there is no group owner.

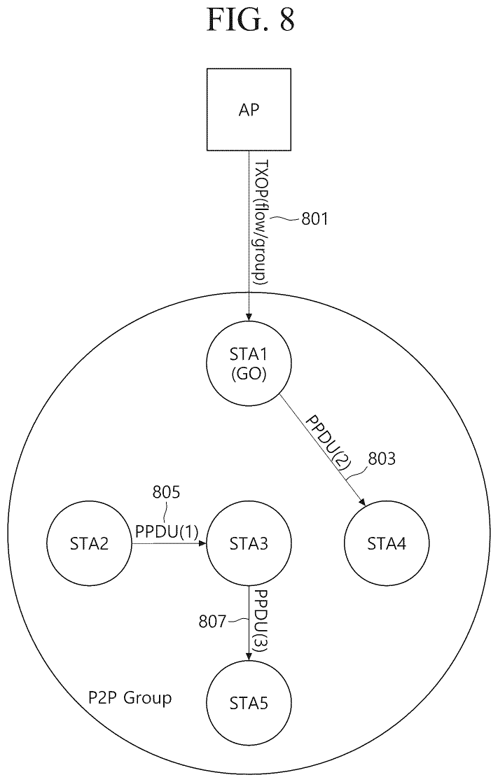

FIG. 8 illustrates group-based triggering for P2P communication in accordance with an embodiment. In particular, FIG. 8 illustrates an AP and a P2P group that includes STA1 that is the group owner (GO), STA2, STA3, STA4 and STA5. At 801, the AP allocates a TXOP to the P2P group. The TXOP may be allocated to a P2P group based on a identifier, such as a Flow ID, Group ID, among other identification information. Accordingly, during the allocated TXOP, STA1 transmits PPDU 803 to STA4, STA2 transmits PPDU 805 to STA3, and STA3 transmits PPDU 807 to STA5.

In some embodiments, a first STA may be a member of a P2P group that includes one or more peer STAs including the first STA. If the first STA intends to request channel resources from the AP for the P2P group, then the first STA can transmit a Stream Classification Service (SCS) Request frame to the AP. In the SCS request frame, the first STA can indicate that the request is for TXOP allocation for the P2P group. In some embodiments, in order to request channel resources or TXOP, the first STA can send any other management frame and indicate that this management frame is a request for channel resources or TXOP for the P2P group indicated in the requesting management frame.

In some embodiments, in order to indicate a request for channel resources or TXOP for the P2P group, in the SCS request frame sent by the first STA to the AP, the first STA can include a Quality of Service (QOS) Characteristics element. In the QoS Characteristics element included in the SCS Request frame, the first STA can include different parameters such that the requested parameters reflect the total need for channel resources that would be necessary to fulfill the traffic requirement of one or more member STAs of the P2P group. In some embodiments, the QoS Characteristics element or the SCS request frame may also include an identification of the P2P group so that the AP can identify the P2P group in the subsequent resource allocation. In some embodiments, the first STA may also identify in the SCS request frame a list of other STAs in the P2P for which the channel resources have been solicited. In some embodiments, the AID (association ID) or the Media Access Control (MAC) addresses of the P2P STAs can be included in the SCS request frame.

In some embodiments, upon receiving an SCS request frame from a first STA, where the SCS request solicits channel resources for a group of P2P STAs, the AP can decide whether it accepts the requests or not. In some embodiments, if the AP declines the request, the AP may suggest an alternative set of SCS parameters for the SCS setup including parameters that are different from a set of parameters requested by the first STA.

In some embodiments, an AP may receive an SCS request frame from a first STA, where the SCS request frame indicates a request for channel resources for the P2P group. Upon receiving the request, the AP can send an SCS response frame to the STA indicating whether the AP accepts, rejects, or suggests an alternative set of SCS parameters corresponding to the received SCS request. In some embodiments, if the AP suggests an alternative set of parameters, then the AP can include a QOS Characteristics element in the SCS response frame transmitted to the first STA, where the QoS Characteristics element carries SCS parameters corresponding to the parameters suggested by the AP. Subsequently, if the first STA sends a second SCS request frame with the parameters suggested by the AP, then the AP is highly likely to accept the second request.

In some embodiments, an AP may receive an SCS request frame or any other management frame from a first STA that indicates a request for channel resources or TXOP for a group of P2P STAs. If the AP accepts that request and sends an SCS response frame indicating the acceptance of the request to the first STA, then the AP can subsequently send trigger frames to allocate TXOP or channel resources for the P2P group. In some embodiments, the AP may allocate the TXOP in an internal interval and periodicity so that the resources need indicated in the SCS request for the P2P group is satisfied. In some embodiments, the AP can send a multi-user (MU) request-to-send (RTS) triggered TXOP (TXS) trigger frame for the P2P group and indicate that this trigger frame is for the group of P2P STAs. In some embodiments, the trigger frame can be a mode-2 variant of the MU-RTS TXS trigger frame. In some embodiments, the trigger frame can be a variant of the MU-RTS TXS trigger frame. In some embodiments, the trigger frame can be a trigger frame that can be defined for TXOP allocation for a P2P group.

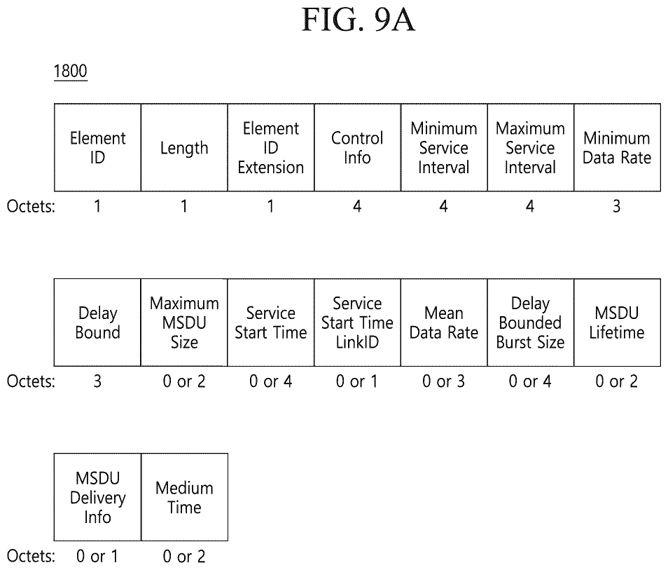

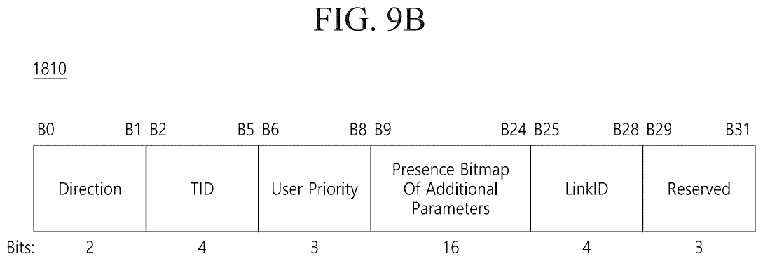

FIG. 9A shows an example of a QoS characteristic element and FIG. 9B shows an example of a Control Info field within the QoS characteristic element in accordance with an embodiment.

Referring to FIG. 9A, the QoS characteristic element 900 includes an Element ID field, a Length field, an Element ID Extension field, a Control field, a Maximum Service Interval field, a Minimum Service Interval field, a Minimum Date Rate field, a Delay Bound field, a Maximum MSDU Size field, a Service Start Time field, a Service Start Time Link ID field, a Mean Date Rate field, a Delay Bounded Burst Size field, a MSDU Lifetime field, a MSDU Delivery Info field, and Medium Time field.

Referring to FIG. 9B, the Control Info field 910 includes a Direction subfield, a TID subfield, a User Priority subfield, a Presence Bitmap of Additional Parameters subfield, a Link ID subfield, and Reserved bits. The Direction subfield indicates the direction of data, such as uplink, downlink, or direct link. The direct link indicates that frames, more specifically MSDUs or A-MSDUs, are sent over a P2P link to a peer STA. The TID subfield indicates a TID value of data frame described by the QoS characteristic element 900. The User Priority subfield indicates the user priority value (0-7) of the data frames described by the QoS characteristic element 900. The Presence Bitmap Of Additional Parameters subfield indicates a bitmap where the i-th entry of the bitmap is set to 1 if the i-th field starting from the Maximum MSDU Size field is present in QoS characteristic element 900. The Link ID subfield contains the link identifier that corresponds to the link for which the direct link transmissions are going to occur.

The Minimum Service Interval field in FIG. 9A may indicate the minimum interval between the start of two consecutive service periods that are allocated to an STA for direct link frame exchanges when the Direction subfield in FIG. 9B is set to the direct link.

The Maximum Service Interval field in FIG. 9A may indicate the maximum interval between the start of two consecutive service periods that are allocated to an STA for direct link frame exchanges when the Direction subfield in FIG. 9B is set to the direct link.

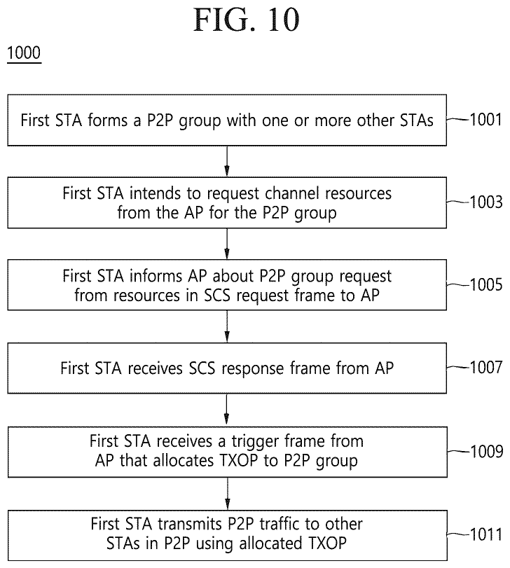

FIG. 10 illustrates a flow chart of an example process 1000 of requesting resources for a P2P group in accordance with an embodiment. Although one or more operations are described or shown in particular sequential order, in other embodiments the operations may be rearranged in a different order, which may include performance of multiple operations in at least partially overlapping time periods.

The process 1000 may begin in operation 1001. In operation 1001, a first STA forms a P2P group with one or more other peer STAs.

In operation 1003, the first STA intends to request channel resources (e.g., TXOP) from an infrastructure AP that is associated with the first STA, where the channel resources are requested for the P2P group.

In operation 1005, the first STA informs the AP about the P2P group request for resources. In some embodiments, the first STA may send an SCS request frame to the AP including a QoS Characteristic element. In the QoS Characteristics element included in the SCS Request frame, the first STA can include different parameters appropriately so that the requested parameters reflect the total need for channel resources that would be necessary to fulfill the traffic requirement of one or more members of the P2P group. In some embodiments, the QoS Characteristics element or the SCS request frame may also include an identification of the P2P group so that the AP can identify the P2P group in the subsequent resource allocation. In certain embodiment, the first STA can also identify in the SCS request frame a list of other STAs in the P2P group for which the channel resources have been solicited. For instance, the AID (association ID) or the MAC addresses of the P2P STAs can be included in the SCS request frame.

In operation 1007, the first STA receives an SCS response frame from the AP. In some embodiments, the SCS response frame may indicate the acceptance of the request by the SCS request frame. In certain embodiments, the SCS response frame may not accept the request but transmit an alternative set of SCS parameters for the SCS setup including parameters that are different from the ones requested by the first STA. If the AP suggests an alternative set of parameters, then the AP can include a QoS Characteristics element in the SCS response frame transmitted to the first STA, where the QoS Characteristics element carries SCS parameters corresponding to the parameters suggested by the AP. Subsequently, the first STA may send a second SCS request frame with the parameters suggested by the AP, and then the AP may accept the second request.

In operation 1009, the first STA receives a trigger frame from AP that allocates TXOP to the P2P group. In some embodiments, a MU-RTS TXS (Mode 2) trigger frame may be used as the trigger frame and may indicate that this trigger frame is for the group of P2P STAs. The allocated TXOP may be determined by AP based on the parameters within the QoS Characteristic element of the SCS request frame. The allocated TXOP may be a portion of the AP's TXOP.

In operation 1011, the first STA transmits P2P traffic to one or more peer STAs in the P2P group during the allocated TXOP.

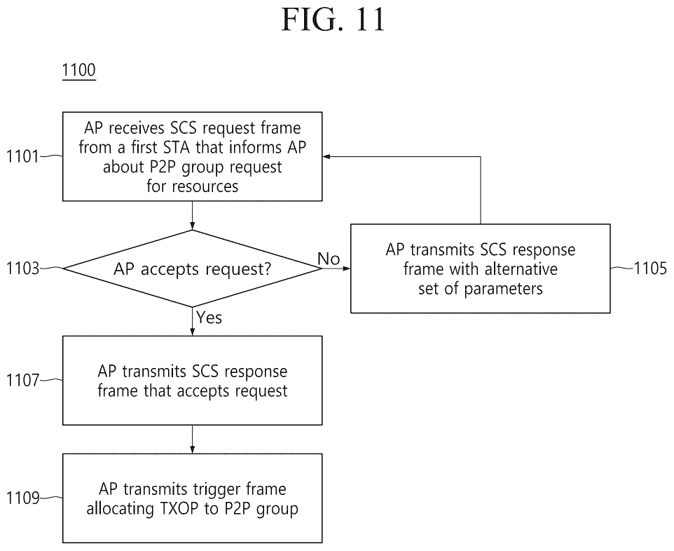

FIG. 11 illustrates a flow chart of an example process 1100 of an AP allocating resources to a P2P group in accordance with an embodiment. Although one or more operations are described or shown in particular sequential order, in other embodiments the operations may be rearranged in a different order, which may include performance of multiple operations in at least partially overlapping time periods.

The process 1100 may begin in operation 1101. In operation 1001, an AP receives from a first STA a request for resources (e.g., TXOP) for a P2P group. In some embodiments, the AP may receive an SCS request frame from the first STA that includes a QoS Characteristic element. In the QoS Characteristics element included in the SCS Request frame, the first STA can include different parameters appropriately so that the requested parameters reflect the total need for channel resources that would be necessary to fulfill the traffic requirement of one or more members of the P2P group. In some embodiments, the QoS Characteristics element or the SCS request frame may also include an identification of the P2P group so that the AP can identify the P2P group in the subsequent resource allocation. In a certain embodiment, the first STA can also identify in the SCS request frame a list of other STAs in the P2P group for which the channel resources have been solicited. For instance, the AID (association ID) or the MAC addresses of the P2P STAs can be included in the SCS request frame.

In operation 1103, the AP determines whether to accept the request for resources. If in operation 1103, the AP does not accept the request for resources, then in operation 1105, the AP may transmit an alternative set of SCS parameters for the SCS setup including parameters that are different from the ones requested by the first STA. In some embodiments, the alternative set of parameters can be included a QoS Characteristics element in the SCS response frame transmitted to the first STA, where the QoS Characteristics element carries SCS parameters corresponding to the parameters suggested by the AP. Subsequently, the AP may receive from the first STA a second SCS request frame with the parameters suggested by the AP, and then the AP may accept the second request.

If in operation 1103, the AP accepts the request, then in operation 1107, the AP may transmit an SCS response frame that indicates the acceptance of the request by the SCS request frame.

In operation 1109, the AP may transmit to the first STA a trigger frame that allocates TXOP to the P2P group. In some embodiments, a MU-RTS TXS (Mode 2) trigger frame may be used as the trigger frame and may indicate that this trigger frame is for the group of P2P STAs. The allocated TXOP may be determined by the AP based on the parameters within the QoS Characteristic element of the SCS request frame. The allocated TXOP may be a portion of the AP's TXOP.

Embodiments in accordance with this disclosure provide mechanisms by which an AP can allocate channel resources (e.g., TXOP) to a group of STAS, where the STAs are within a P2P group, which may improve wireless network traffic performance and thereby enhance a multi-device connectivity experience. The TXOP request procedures in accordance with embodiments described herein may be utilized to maintain seamless latency-sensitive traffic flow and improve overall system efficiency.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A station (STA) in a wireless network, comprising:
a memory; and
a processor coupled to the memory, the processor configured to:
transmit, to an access point (AP), a request frame that requests a resource from the AP for a P2P group to which the STA belongs;
receive, from the AP, a trigger frame that allocates a transmission opportunity (TXOP); and
transmit, to a peer STA in the P2P group, one or more frames within the TXOP.

2. The STA of claim 1, wherein the processor is further configured to:
transmit, to the peer STA, a frame that reallocates a portion of the TXOP.

3. The STA of claim 1, wherein the processor is further configured to:
receive, from the AP, a response frame in response to the request frame, the response frame including an indication of acceptance, rejection, or an alternative to the request in the request frame.

4. The STA of claim 3, wherein the response frame includes a quality of service (QOS) characteristics element that includes the alternative to the request in the request frame.

5. The STA of claim 1, wherein the request frame includes a P2P group identifier or a flow identifier that identifies the P2P group, wherein the flow identifier is a stream classification service identifier or a target-wake-time (TWT) flow identifier.

6. The STA of claim 1, wherein the request frame includes a quality of service (QOS) characteristics element that includes information associated with a traffic requirement of the P2P group.

7. The STA of claim 1, wherein the request frame includes information on one or more peer STAs in the P2P group for which the resource is requested.

8. An access point (AP) in a wireless network, comprising:
a memory; and
a processor coupled to the memory, the processor configured to:
receive, from a station (STA), a request frame that requests a resource from the AP for a P2P group to which the STA belongs; and
transmit, to the STA, a trigger frame that allocates a transmission opportunity (TXOP) to the P2P group.

9. The AP of claim 8, wherein the processor is further configured to:
transmit, to the STA, a response frame in response to the request frame, the response frame including an indication of acceptance, rejection, or an alternative to the request in the request frame.

10. The AP of claim 9, wherein the response frame includes a quality of service (QOS) characteristics element that includes the alternative to the request in the request frame.

11. The AP of claim 8, wherein the request frame includes a P2P group identifier or a flow identifier that identifies the P2P group, wherein the flow identifier is a stream classification service identifier or a target-wake-time (TWT) flow identifier.

12. The AP of claim 8, wherein the request frame includes a quality of service (QOS) characteristics element that includes information associated with a traffic requirement of the P2P group.

13. The AP of claim 8, wherein the request frame includes information on one or more peer STAs in the P2P group for which the resource is requested.

14. A computer-implemented method for communication by a station (STA) in a wireless network, comprising:
transmitting, to an access point (AP), a request frame that requests a resource from the AP for a P2P group to which the STA belongs;
receiving, from the AP, a trigger frame that allocates a transmission opportunity (TXOP); and
transmitting, to a peer STA in the P2P group, one or more frames within the TXOP.

15. The computer-implemented method of claim 14, further comprising:
transmitting, to the peer STA, a frame that reallocates a portion of the TXOP.

16. The computer-implemented method of claim 14, further comprising:
receiving, from the AP, a response frame in response to the request frame, the response frame including an indication of acceptance, rejection, or an alternative to the request in the request frame.

17. The computer-implemented method of claim 16, wherein the response frame includes a quality of service (QOS) characteristics element that includes the alternative to the request in the request frame.

18. The computer-implemented method of claim 14, wherein the request frame includes a P2P group identifier or a flow identifier that identifies the P2P group, wherein the flow identifier is a stream classification service identifier or a target-wake-time (TWT) flow identifier.

19. The computer-implemented method of claim 14, wherein the request frame includes a quality of service (QOS) characteristics element that includes information associated with a traffic requirement of the P2P group.

20. The computer-implemented method of claim 14, wherein the request frame includes information on one or more peer STAs in the P2P group for which the resource is requested.
